(19) United States
(12) Patent Application Publication
(10) Pub. No.: US 2018/0042281 A1
(43) Pub. Date: Feb. 15, 2018

(54) ULTRASONIC ROCK SALT CONTINUOUS CLEANING DEVICE AND METHOD THEREOF

(71) Applicant: Jointt Holdings Group Co., LTD., Hong Kong (CN)

(72) Inventors: Shun BAI, Hong Kong (CN); Jiangqiang HUANG, Hong Kong (CN); Yongliang LIU, Hong Kong (CN); Hao Tu, Hong Kong (CN)

(21) Appl. No.: 15/673,026

(22) Filed: Aug. 9, 2017

Related U.S. Application Data
(63) Continuation of application No. PCT/CN2016/094353, filed on Aug. 10, 2016.

(51) Int. Cl. A23L 27/40

(52) U.S. Cl. CPC A23L 27/40; B08B 3/12

(57) ABSTRACT

An ultrasonic rock salt continuous cleaning method and an ultrasonic rock salt continuous cleaning device are provided. The ultrasonic rock salt continuous cleaning method comprises, in a loading and pre-examining stage, loading and pre-examining a solid substance, where first sample information of the solid substance is collected; in a pre-cleaning stage, pre-cleaning the solid substance, wherein a cleaning fluid is applied; in an ultrasonic cleaning stage, ultrasonic cleaning the solid substance; in a drying stage, drying the solid substance, where the solid substance is dried in two stages, in a first stage, the solid substance is dried using a high-pressure air, and in a second stage, the solid substance is dried using hot air; and in an unloading and examining stage, unloading and examining the rock salts, where second sample information of the solid substance is collected.

### CROSS-REFERENCES TO RELATED APPLICATIONS

This application claims priority of International Patent Application No. PCT/CN2016/094353, filed on Aug. 10, 2016, the entire contents of which are hereby incorporated by reference.

### FIELD OF THE DISCLOSURE

The present disclosure generally relates to the technical field of rock salt cleaning device and, more particularly, relates to an ultrasonic rock salt continuous cleaning device and method thereof.

### BACKGROUND

Rock salt is a type of naturally formed and directly edible mineral salt with a content of sodium chloride over 98%. Other elements in the rock salt include dozens of minerals essential to human bodies, such as iron, calcium, magnesium, potassium, aluminum, zinc, gallium, and silicon, etc. A typical type of rock salts is Himalayan rock salt. Himalayan rock salt is primarily produced in the Himalaya Mountain region, and is a salt exploited from 600-meter deep mine in the Himalayan mountains. Further, Himalayan rock salt has the largest reserve and highest purity among crystal salt mineral resources over the world, and thus is a scarce resource.

Himalayan rock salt is currently one of the most popular rock salt products in the domestic and international markets. The development of salt products that use the Himalayan salt as the raw material is very fast. Other than being edible, the Himalayan salt can be also used for purpose of beauty and health, and has very high exploitation value.

However, because of reasons such as the intrinsic crystal structure, Himalayan salt may form irregular shapes. Further, cracks, fissures, and pores, etc., may easily occur in the Himalayan salt, thereby bringing in stains such as dust and soil, etc. Accordingly, the rock salt needs to be cleaned in the production process. Currently, only traditional blowing-type cleaning, immersion-type cleaning, brush cleaning, and spray cleaning are used to process the rock salt in cooperation of the cleaning fluid.

Such cleaning methods may not effectively remove stains attached on surface of the rock salt and stains in the crevice of the rock salt blocks, thus placing certain limitations on the exploitation and use of the rock salt. Further, the random cleaning of the rock salt by using a cleaning fluid in the traditional processing progress may result in the waste of the water resources, and the salt water discharge may cause great pollution to the environment. Further, the traditional rock salt cleaning method often induces issues such as high labor cost, low cleaning efficiency, and uncontrollable cleaning quality of the rock salt.

The disclosed ultrasonic rock salt continuous cleaning device and method thereof are directed to solving at least partial problems set forth above and other problems.

### BRIEF SUMMARY OF THE DISCLOSURE

One aspect of the present disclosure provides an ultrasonic rock salt continuous cleaning method. The ultrasonic rock salt continuous cleaning method comprises, in a loading and pre-examining stage, loading and pre-examining a solid substance, where first sample information of the solid substance is collected; in a pre-cleaning stage, pre-cleaning the solid substance, wherein a cleaning fluid is applied; in an ultrasonic cleaning stage, ultrasonic cleaning the solid substance; in a drying stage, drying the solid substance, where the solid substance is dried in two stages, in a first stage, the solid substance is dried using a high-pressure air, and in a second stage, the solid substance is dried using hot air; and in an unloading and examining stage, unloading and examining the rock salts, where second sample information of the solid substance is collected.

Another aspect of the present disclosure provides an ultrasonic rock salt continuous cleaning device. The ultrasonic rock salt continuous cleaning device comprises a loading & pre-examining module, a pre-cleaning module, an ultrasonic cleaning module, a drying module, an unloading & examining module, and an automatic control module. Then loading & pre-examining module is configured to load a solid substance and pre-examine the solid substance. The pre-cleaning module is configured to pre-clean the solid substance using a cleaning fluid. The ultrasonic cleaning module is configured to ultrasonically cleaning the solid substance, where the ultrasonic cleaning module includes an ultrasonic resonator. The drying module is configured to remove moisture of the solid substance. The unloading and examining module is configured to unload and examine the substance. The automatic control module connected to the pre-cleaning module and the ultrasonic cleaning module.

Other aspects of the present disclosure can be understood by those skilled in the art in light of the description, the claims, and the drawings of the present disclosure.

### BRIEF DESCRIPTION OF THE DRAWINGS

Other features, goals, and advantages of the present disclosure will become more apparent via a reading of detailed descriptions of non-limiting embodiments with reference to the accompanying drawings.

FIG. 1 illustrates an exemplary structural view of major modules used in an ultrasonic rock salt continuous cleaning method according to embodiments of the present disclosure;

FIG. 2 illustrates an exemplary front view of an ultrasonic rock salt continuous cleaning device according to embodiments of the present disclosure;

FIG. 3 illustrates an exemplary top view of an ultrasonic rock salt continuous cleaning device according to embodiments of the present disclosure;

FIG. 4 illustrates an exemplary installation diagram of an image stain detection device of an ultrasonic rock salt continuous cleaning device according to embodiments of the present disclosure;

FIG. 5 illustrates an exemplary schematic view of a recycling module in an ultrasonic rock salt continuous cleaning device according to embodiments of the present disclosure;

FIG. 6 illustrates an exemplary schematic view of an air exhausting module in an ultrasonic rock salt continuous cleaning device according to embodiments of the present disclosure; and

FIG. 7 illustrates an exemplary flow chart of an ultrasonic rock salt continuous cleaning method according to embodiments of the present disclosure.

### DETAILED DESCRIPTION

The foregoing and other objects, features, and advantages of the present disclosure will be more apparent from the following description of embodiments as illustrated in the accompanying drawings. The drawings are not necessarily to scale, emphasis instead being placed upon illustrating principles of the present disclosure.

Specific details are set forth in the following descriptions to provide a full understanding of aspects and embodiments of the present disclosure. The present disclosure may also be implemented through various manners other than those described herein, and similar variations and modifications can be made by those skilled in the art without departing from the spirit and scope of the present disclosure. Therefore, the present disclosure is not limited to specific embodiments disclosed hereinafter.

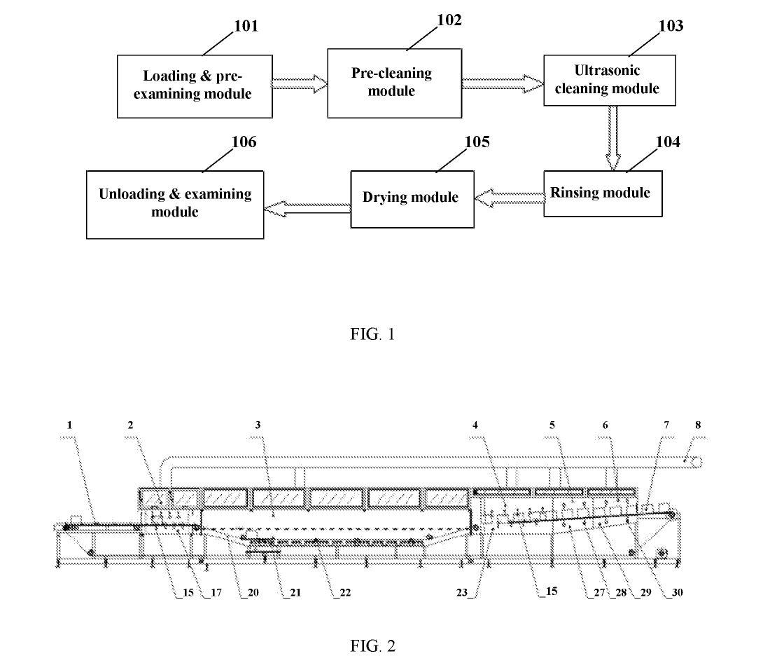

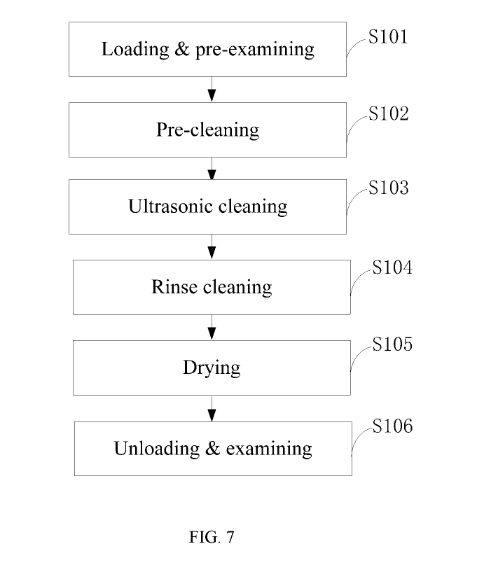

The present disclosure provides an ultrasonic rock salt continuous cleaning method. FIG. 1 illustrates an exemplary structural view of major modules used in an ultrasonic rock salt continuous cleaning method according to embodiments of the present disclosure. FIG. 7 illustrates an exemplary flow chart of an ultrasonic rock salt continuous cleaning method according to embodiments of the present disclosure.

As shown in FIG. 1, major modules used in an ultrasonic rock salt continuous cleaning method may include a loading & pre-examining module 101, a pre-cleaning module 102, an ultrasonic cleaning module 103, a rinsing module 104, a drying module 105, and an unloading & examining module 106. The loading & pre-examining module 101 may be configured to fulfill a loading & pre-examining process of a rock salt. The pre-cleaning module 102 may be configured to fulfill a pre-cleaning process of the rock salt.

Further, the ultrasonic cleaning module 103 may be configured to fulfill an ultrasonic cleaning process of the rock salt. The rinsing module 104 may be configured to fulfill a rinsing process of the rock salt. The drying module 105 may be configured to fulfill a drying process of the rock salt. The unloading & examining module 106 may be configured to fulfill an unloading & examining process of the rock salt.

Optionally, the pre-cleaning module 102 and the ultrasonic cleaning module 103 may be connected to an automatic control module. For example, the automatic control module may be configured to control pre-cleaning parameters, such as cleaning time, in the pre-cleaning module 102. The automatic control module may be further configured to control ultrasonic cleaning parameters, such as frequency of an ultrasonic resonator, in the ultrasonic cleaning module 103.

Further, the specific working process of the ultrasonic rock salt continuous cleaning method is illustrated in detail hereinafter with reference to FIG. 1 and FIG. 7. As shown in FIG. 7 and referring to FIG. 1, the ultrasonic rock salt continuous cleaning method may include the following steps (S101˜S106).

S101: A rock salt may be loaded and pre-examined. More specifically, in step S101, sample information of the rock salt may be collected, and the collected sample information may be compared with preset sample information to obtain a stain degree of the rock salt. Optionally, the sample information of the rock salt may be image information of the rock salt. Further, the step S101 may be implemented in the loading & pre-examining module 101. Optionally, the shape of the rock salt may be regular or irregular.

S102: The rock salt may be pre-cleaned. More specifically, in step S102, the rock salt may be pre-cleaned by using a cleaning fluid. The cleaning fluid may be, for example, released towards the rock salt via one or a plurality of nozzles. Further, based on the stain degree of the rock salt obtained in step S101, the pressure of each nozzle that releases the cleaning fluid may be controlled, and the cleaning time may be adjusted to improve the cleaning efficiency.

Optionally, the cleaning fluid may be saturated salt water (e.g., a saturated sodium chloride solution), such that the effective ingredients of the rock salt may not be dissolved by the cleaning fluid. Optionally, in step S102, the cleaning fluid may be released under a high pressure. Further, step S102 may be implemented in the pre-cleaning module 102.

S103: The rock salt may be ultrasonic cleaned. More specifically, in step S103, the rock salt may be ultrasonic cleaned in an ultrasonic cleaning tank filled with a cleaning fluid, and the liquid turbidity of the cleaning fluid may be detected via a liquid turbidity detector.

Further, based on the detected liquid turbidity, whether or not the cleaning fluid needs to be refreshed may be determined.

For example, when the detected liquid turbidity is greater than a preset value, the cleaning fluid in the ultrasonic cleaning tank may be extracted and fresh cleaning fluid may be supplied into the ultrasonic cleaning tank. Optionally, a plurality of liquid turbidity detectors may be disposed in the ultrasonic cleaning tank, and when one liquid turbidity detector detects a liquid turbidity greater than a preset value, the cleaning fluid in the ultrasonic cleaning tank may be refreshed.

Optionally, the cleaning fluid in step S103 may be the same as the cleaning fluid in step S102. For example, the saturated salt water may be applied as the cleaning fluid in step S103. Optionally, a plurality of ultrasonic resonators may be applied to assist ultrasonic cleaning of the rock salt. In one embodiment, when the saturated salt water is used as the cleaning fluid, the ultrasonic power that controls the vibration frequency of the plurality of ultrasonic resonators may be configured to have a power density of approximately 16 W/L.

Because the salt water has a relatively large density, a relatively large surface tension, and viscosity higher than pure water, the cavitation threshold of the cavitation effect generated by the cleaning fluid may be relatively large. Accordingly, the ultrasonic power may be configured to have a power density of approximately 16 W/L. Under such power density, the strength of cavitation effect may be adjusted by adjusting the power, thereby achieving satisfying cleaning effect. Further, step S103 may be implemented in the ultrasonic cleaning module 103.

S104: The rock salt may undergo rinse cleaning. More specifically, a fresh cleaning fluid (e.g., salt water) may be applied to rinse the rock salt, for example, via a plurality of nozzles. Further, after the rock salt is rinsed, the cleaning fluid may be filtered and recycled for the rinsing process again. Further, S104 may be implemented in the rinsing module 104.

Optionally, after rinsing the rock salt and before being filtered and recycled, the cleaning fluid used in step S104 may be applied to pre-clean rock salts in step S102. Optionally, in step S104, the cleaning fluid may be sprayed under a high pressure. Optionally, step S104 may not be needed. For example, when the liquid turbidity of the cleaning liquid detected in step S103 does not exceed a preset value, step S104 may be omitted.

S105: The rock salt may be dried. More specifically, the drying process may include two stages. In the first stage, the rock salt may be dried by using high-pressure air to remove most moisture. In the second stage, the rock salt may be further dried by using hot air. That is, because the temperature is increased, the surface of the rock salts may be further dried. Such drying treatment may prevent loss of effective ingredients of the rock salt. Further, S105 may be implemented in the drying module 105.

S106: The rock salt may be unloaded and examined. More specifically, in step S106, the sample information (e.g., an image information) of the rock salt may be collected, and the collected sample information may be compared with preset sample information (e.g., preset image information) to obtain a stain degree of the rock salt. When the stain degree of the rock salt exceeds a preset value, an alarm sound may be triggered to indicate that the rock salt is ineligible.

Further, when the number of the ineligible rock salts exceeds a pre-determined value, the frequency of the plurality of ultrasonic resonators may be increased to enhance the ultrasonic cleaning effect. Further, when the ratio of ineligible rock salts exceeds a preset ratio, another type of alarm sound may be triggered to indicate that additional attention needs to be paid to the working performance of the cleaning device.

Further, S106 may be implemented in the unloading & examining module 106. After step S106 is completed, the cleaning process is fulfilled.

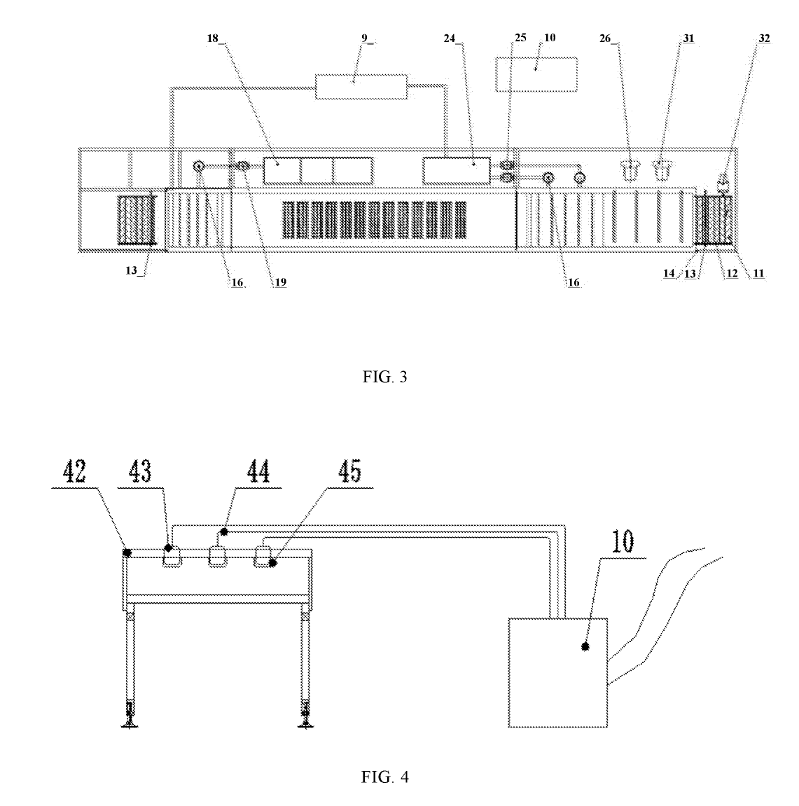

The present disclosure also provides an ultrasonic rock salt continuous cleaning device. FIG. 2 illustrates an exemplary front view of an ultrasonic rock salt continuous cleaning device according to embodiments of the present disclosure. FIG. 3 illustrates an exemplary top view of an ultrasonic rock salt continuous cleaning device according to embodiments of the present disclosure.

As shown in FIG. 2 and FIG. 3, the ultrasonic rock salt continuous cleaning device may include a loading & pre-examining module 1, a pre-cleaning module 2, an ultrasonic cleaning module 3, a drying module, an unloading & examining module 7, an air exhausting module 8, a recycling module 9, and an automatic control module 10. Optionally, the ultrasonic rock salt continuous cleaning device may further include a rinsing module 4. Optionally, the ultrasonic rock salt continuous cleaning device may further include a mesh belt 11, a chain 12, a rack 14, and a driving motor 32.

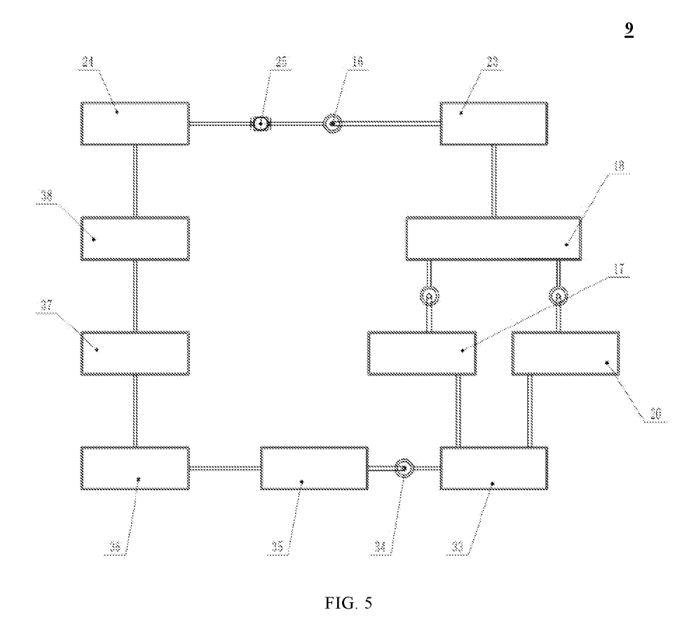

More specifically, the loading & pre-examining module 1 may be configured to load the rock salts and pre-examine the loaded rock salts. The loading process may be a manual process or an automatic process. Further, the loading & pre-examining module 1 may include an image stain detection device 13. FIG. 4 illustrates an exemplary installation diagram of an image stain detection device 13 in an ultrasonic rock salt continuous cleaning device according to embodiments of the present disclosure.

As shown in FIG. 4, the image stain detection device 13 may include a support 42, an imaging unit 43, a transmission unit 44, and a protecting unit 45. In one embodiment, the imaging unit 43 may include a plurality of cameras. In another embodiment, the imaging unit 43 may include a plurality of video recorders. Hereinafter, the imaging unit 43 is assumed to include a plurality of cameras for illustrative purposes. Further, the transmission unit 44 may include a plurality of transmission lines, and the protecting unit 45 may include a plurality of protecting covers.

More specifically, the imaging unit 43 may be mounted onto the support 42. Each camera included in the imaging unit 43 may be connected to the automatic control module 10 via a transmission line. Further, each camera may be covered by a protecting cover, and the protecting cover may provide a protection function. Optionally, the support 42 of the image stain detection device 13 included in the loading & pre-examining module 1 may be integrally connected to a holder of the loading & pre-examining module 1, for example, via a welding process, to form a rigid frame.

In the loading & pre-examining module 1, the image stain detection device 13 may be configured to collect image information of rock salts. More specifically, the image information of the rock salts collected by the imaging unit 43 in the image stain detection device 13 may be transmitted to the automatic control module 10 via the transmission unit 44 for image comparison with a preset image signal.

Optionally, the loading & pre-examining module 1 may be connected to the rack 14 via the mesh belt 11. The chain 12 may be configured to transport the rock salts from the loading & pre-examining module 1 to the unloading & examining module 7 driven by the driving motor 32.

The pre-cleaning module 2 may be configured to pre-clean the rock salts transferred from the loading & pre-examining module 1. That is, after being processed by the loading & pre-examining module 1, the rock salts may enter the pre-cleaning module 2. More specifically, the pre-cleaning module 2 may include a plurality of spraying nozzles 15, a filtering unit 16, a spraying & pre-cleaning tank 17, a high-pressure spraying & pre-cleaning storage tank 18, and a frequency-conversion control water bump 19.

The pre-cleaning module 2 may be configured to extract a cleaning fluid from the high-pressure spraying & pre-cleaning storage tank 18 via the frequency-conversion control water bump 19. The frequency-conversion control water bump 19 may be coupled to the plurality of nozzles 15 that spray the extracted cleaning fluid to adjust the spraying speed of the cleaning fluid. The sprayed cleaning fluid may flow in the spraying & pre-cleaning tank 17.

Further, the frequency-conversion control water bump 19 may be connected to the automatic control module 10. Under control of the automatic control module 10, the frequency-conversion control water bump 19 included in the pre-cleaning module 2 may change the inlet and outlet flow, and the pressure and cleaning time of each nozzle 15 may be adjusted.

The ultrasonic cleaning module 3 may comprise an ultrasonic cleaning tank 20, an ultrasonic resonator unit 21 including an ultrasonic resonator, and a liquid turbidity detection unit 22. The ultrasonic cleaning tank 20 may be configured to hold a cleaning fluid. More specifically, the ultrasonic cleaning tank 20 may be designed to have a left portion, a middle portion, and a right portion.

The left portion of the ultrasonic cleaning tank 20 may be bent upwards with respect to the middle portion at a certain angle (e.g., 30 degrees). Similarly, the right portion of the ultrasonic cleaning tank 20 may be bent upwards with respect to the middle portion at a certain angle (e.g., 30 degrees). That is, the left portion and the right portion may be configured to be symmetric. Further, the middle portion may be configured to have a flat bottom.

Further, the ultrasonic resonator unit 21 and the liquid turbidity detection unit 22 may be disposed inside the ultrasonic cleaning tank 20. For example, the ultrasonic resonator unit 21 and the liquid turbidity detection unit 22 may be disposed in the middle portion of the ultrasonic cleaning tank 20. Optionally, the ultrasonic resonator unit 21 may not contact the rock salts directly. For example, the ultrasonic resonator unit 21 may be placed below the mesh belt 11 while the rock salts are placed on the mesh belts. Further, the ultrasonic resonator unit 21 and the rock salts are immersed in the cleaning fluid, and the rock salts may be cleaned via the cavitation effect of the ultrasonic waves generated by the ultrasonic resonator unit 21.

Further, the ultrasonic resonator unit 21 and the liquid turbidity detection unit 22 may be connected to the automatic control module 10, respectively. The ultrasonic resonator unit 21 may be configured to detect the frequency of the ultrasonic resonator. The liquid turbidity detection unit 22 may be configured to detect the liquid turbidity of the cleaning fluid in the ultrasonic cleaning tank 20. The detected information such as the frequency of the ultrasonic resonator and the liquid turbidity of the cleaning fluid may be transmitted to the automatic control module 10.

Based on the detected frequency of the ultrasonic resonator fed back to the automatic control module 10, the automatic control module 10 may control and adjust the frequency of the resonator. Further, based on the liquid turbidity of the cleaning fluid fed back to the automatic control module 10, the automatic control module 10 may be configured to control whether the ultrasonic cleaning tank 20 changes the cleaning fluid or not.

Optionally, the ultrasonic resonator unit 21 may include a plurality of ultrasonic resonators. The plurality of ultrasonic resonators may resonate on the flat bottom of the middle portion of the ultrasonic cleaning tank 20. Or, optionally, the plurality of ultrasonic resonators may be placed and resonate in a plurality of holders fixedly attached on the bottom of the ultrasonic cleaning tank 20. Further, the number of ultrasonic resonators disposed in each holder may be the same or different, and the plurality of ultrasonic resonators, together with the plurality of holders, may be configured to generate ultrasonic waves.

For example, as shown in FIG. 2, the plurality of ultrasonic resonators may be placed in thirteen holders fixedly attached at the same intervals on the bottom of the ultrasonic cleaning tank 20. Each of the thirteen holders may include three rows of resonators, and each row of resonators may include a plurality of resonators.

Optionally, the ultrasonic cleaning module 3 may include a plurality of liquid turbidity detection units 22. For example, as shown in FIG. 2, four liquid turbidity detection units 22 may be disposed in the middle portion of the ultrasonic cleaning tank 20.

Optionally, the cleaning fluid in the ultrasonic cleaning tank 20 may be saturated salt water (e.g., NaCl, or KCl). The saturated salt water may be chosen as the cleaning fluid because of reasons such as being unable to dissolve the effective ingredient of the rock salts, having a relatively large density, a relatively large surface tension, and viscosity higher than pure water. Accordingly, the cavitation threshold of the cavitation effect generated by the cleaning fluid may be relatively large.

Further, the power density of the ultrasonic power may be approximately 16 W/L. Under such power density, the power may be adjusted to vary the strength of the cavitation effect to achieve satisfying cleaning effect.

Further, the contamination of the cleaning fluid in the whole cleaning process may be sensed, monitored, and processed. For example, the ultrasonic cleaning module 3 may further include an outlet, an overflow port, and a sewage draining exit. Because the liquid turbidity detection unit(s) 22 may be configured to feed back the detected information (e.g., liquid turbidity) to the automatic control module 10, the automatic control module 10 may change the cleaning fluid in the ultrasonic cleaning module 3.

After going through the ultrasonic cleaning module 3, the rock salts may enter the drying module. The drying module may include a high-pressure air knife water-removing unit 5 and a hot air drying unit 6. More specifically, the high-pressure air knife water-removing unit 5 may include a high-pressure air bump 26, an air knife 27, and a water-removing tank 28. The high-pressure air knife water-removing unit 5 may be configured to remove water from surface of rock salts by applying a high-pressure air.

For example, after the rock salts pass through the air knife 27 in the high-pressure air knife water-removing unit 5, most moisture on surface of the rock salts may be removed. Optionally, a pair of air knives 27 may be disposed on the upper and lower sides of the high-pressure air knife water-removing unit 5 to remove the moisture on surface of the rock salts. More specifically, the pair of air knives 27 may include an upper air knife and a lower air knife. The lower air knife may be disposed below the mesh belt 11 and within a proper distance to the bottom of the rock salts. The upper air knife may be disposed above the mesh belt 11 and within a proper distance to the top of the rock salts. The distance from the lower air knife to the rock salts and the distance from the upper air knife to the rock salts may be adjusted, respectively.

The hot air drying unit 6 may include a drying oven 29, a hot air knife 30, and a hot air bump 31. The hot air bump 31 may be configured to generate a hot wind, and the hot wind generated by the hot air bump 31 may be blown out towards the rock salts via the hot air knife 30. After pass through the high-pressure air knife water-removing unit 5, the rock salts may enter the hot air drying unit 6. Accordingly, the surface temperature of the rock salts may be increased, such that the rock salts may be further dried. Optionally, a pair of hot air knives 30 may be disposed on the upper and lower sides of the hot air drying unit 6.

Optionally, a rinsing module 4 may be disposed between the ultrasonic cleaning module 3 and the high-pressure air knife water-removing unit 5. The rinsing module 4 may be a high-pressure spraying and rinsing module. Further, the rinsing module 4 may include a plurality of spraying nozzles 15, and a high-pressure spraying & rinsing tank 23.

When under work, the rinsing module 4 may extract the cleaning fluid from the high-pressure spraying and rinsing storage tank 24 using the high-pressure water pump 25. Optionally, the rinsing module 4 may further include a filtering unit 16 disposed between the high-pressure water bump 25 and the high-pressure spraying & rinsing tank 23. The filtering unit 16 may be configured to filter the cleaning fluid extracted from the high-pressure spraying and rinsing storage tank 24 before the cleaning fluid flows into the high-pressure spraying & rinsing tank 23. The rinsing module 4 may be further configured to spray the cleaning fluid to the rock salts via the plurality of spraying nozzles 15. The high-pressure spraying & rinsing tank 23 may be configured to hold and let the sprayed cleaning fluid flow therein.

Further, the unloading & examining module 7 may include an image stain detection device 13. In one embodiment, the image stain detection device 13 in the unloading & examining module 7 may be the same as the image stain detection device 13 in the loading & pre-examining module 1. For example, the support 42 of the image stain detection device 13 included in the unloading & examining module 7 may be integrally connected to a holder of the unloading & examining module 7 (e.g., via a welding process) to form a rigid frame.

Further, the image stain detection device 13 in the unloading & examining module 7 may be configured to collect the image information of the rock salts, and the image information may be transmitted to the automatic control module 10 via the transmission line 44. When the stain degree of a rock salt exceeds a preset value, the automatic control module 10 may send out an alarm signal to remind quality inspection personnel that the specific rock salt fails to satisfy the standard.

Further, if the amount of ineligible rock salts exceeds a preset value, the automatic control module 10 may send out a signal that automatically control the ultrasonic cleaning module 3 to increase the frequency of the ultrasonic resonate 21, such that the cleaning effect of the ultrasonic cleaning may be enhanced. Further, when the ratio of ineligible rock salts exceeds a preset ratio, the automatic control module 10 may send out another type of alarm signal that reminds the quality inspection personnel to closely monitor the performance of the device.

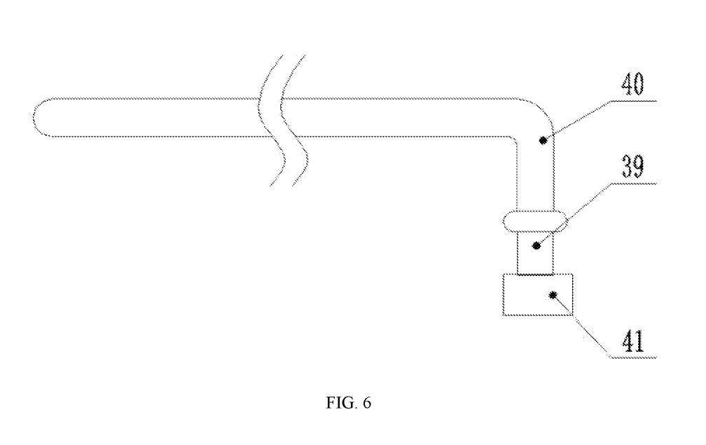

FIG. 6 illustrates an exemplary schematic view of an air exhausting module in an ultrasonic rock salt continuous cleaning device according to embodiments of the present disclosure. As shown in FIG. 6, the air exhausting module 8 may include an air-exhausting fan 39, an air-exhausting pipe 40, and a condensing unit 41.

Referring to FIG. 2 and FIG. 6, one end of the air-exhausting pipe 40 may be connected to the pre-cleaning module 2, the ultrasonic cleaning module 3, the rinsing module 4, and the drying module, respectively. The other end of the air-exhausting pipe 40 may be connected to the air-exhausting fan 39, and the air-exhausting fan 39 may be connected to the condensing unit 41.

The air-exhausting fan 39 may be configured to extract water mist generated by the pre-cleaning module 2, the ultrasonic cleaning module 3, the rinsing module 4, and the drying module via the air-exhausting pipe 40. The water mist extracted by the air-exhausting fan 39 may be re-condensed into water, thereby returning back to the high-pressure spraying & pre-cleaning fluid storage tank 18.

Further, a recycling module 9 may be configured to implement continuous cleaning of the disclosed cleaning device. FIG. 5 illustrates an exemplary schematic view of a recycling module 9 in an ultrasonic rock salt continuous cleaning device according to embodiments of the present disclosure.

The recycling module 9 may include a to-be-processed water tank 33, a water bump 34, a quartz sand filtering unit 35, an activated carbon filtering unit 36, a UV sterilization system 37, and a security filtering unit 38. The water bump 34 may be disposed adjacent to the to-be-processed tank 33. Further, the recycling module 9 may include a high-pressure spraying & rinsing storage tank 24, a high-pressure water bump 25, a filtering unit 16, a high-pressure spraying & rinsing tank 23, a high-pressure spraying & pre-cleaning fluid storage tank 18, a spraying & pre-cleaning tank 17, and an ultrasonic cleaning tank 20. As described above, the filtering unit 16 and the high-pressure spraying & rinsing tank 23 may together form the rinsing module 4.

More specifically, in the recycling module 9, the rinsing module 4 may extract the cleaning fluid from the high-pressure spraying & rinsing storage tank 24 to spray and rinse the rock salts. The rinsed cleaning fluid may then enter the high-pressure spraying & pre-cleaning storage tank 18 after flowing through the high-pressure spraying & rinsing tank 23. The cleaning fluid in the high-pressure spraying & pre-cleaning storage tank 18 may be configured to pre-clean and perform ultrasonic clean on the rock salts.

Further, the cleaning fluid in the high-pressure spraying & pre-cleaning storage tank 18 may later flow through the spraying & pre-cleaning tank 17 and the ultrasonic cleaning tank 20, respectively, to enter the to-be-processed tank 33. The cleaning fluid in the to-be-processed tank 33 may then sequentially pass through the quartz sand filtering unit 35, the activated carbon filtering unit 36, the UV sterilization system 37, and the security filtering unit 38 to return back to the high-pressure spraying & rinsing storage tank 24.

Accordingly, in the recycling system, fresh cleaning fluid may only need to be supplied to the high-pressure spraying & rinsing storage tank 24 regularly. Further, solid substances filtered out by the quartz sand filtering unit 35, the activated carbon filtering unit 36, and the security filtering unit 38 may be processed timely, thereby achieving a safe, environmental friendly, and power-efficient effect.

It should be noted that, the above detailed descriptions illustrate only preferred embodiments of the present disclosure and technologies and principles applied herein. Those skilled in the art can understand that the present disclosure is not limited to the specific embodiments described herein, and numerous significant alterations, modifications and alternatives may be devised by those skilled in the art without departing from the scope of the present disclosure.

Thus, although the present disclosure has been illustrated in above-described embodiments in details, the present disclosure is not limited to the above embodiments. Any equivalent or modification thereof, without departing from the spirit and principle of the present invention, falls within the true scope of the present invention, and the scope of the present disclosure is defined by the appended claims.

What is claimed is:

1. An ultrasonic rock salt continuous cleaning method, comprising:
in a loading and pre-examining stage, loading and pre-examining a solid substance, wherein first sample information of the solid substance is collected;
in a pre-cleaning stage, pre-cleaning the solid substance, wherein a cleaning fluid is applied;
in an ultrasonic cleaning stage, ultrasonic cleaning the solid substance;
in a drying stage, drying the solid substance, wherein the solid substance is dried by using at least one of a high-pressure air and a hot air; and
in an unloading and examining stage, unloading and examining the rock salts, wherein second sample information of the solid substance is collected.

2. The cleaning method according to claim 1, wherein:
in the loading and pre-examining stage, the first sample information of the solid substance is compared to a preset sample information to obtain a stain degree of the solid substance; and
based on the stain degree of the solid substance, in the pre-cleaning stage, pressure of the cleaning fluid and cleaning time are configured.

3. The cleaning method according to claim 2, wherein:
in the unloading and examining stage, the second sample information of the solid substance is compared to the preset sample information to obtain a stain degree of the solid substance, and
when the stain degree of the solid substance exceeds a preset value, the solid substance is determined to be ineligible.

4. The cleaning method according to claim 3, wherein:
based on a number of ineligible solid substances, frequency of the ultrasonic cleaning in the ultrasonic cleaning stage is controlled.

5. The cleaning method according to claim 4, wherein:
when the stain degree of the solid substance exceeds a pre-determined value, a first alarm sound is triggered.

6. The cleaning method according to claim 4, wherein:
when a ratio of ineligible solid substance exceeds a pre-determined value, a second alarm sound is triggered.

7. The cleaning method according to claim 1, wherein:
the first sample information is image information, and
the second sample information is image information.

8. The cleaning method according to claim 1, wherein:
the solid substance is rock salt.

9. An ultrasonic rock salt continuous cleaning device, comprising:
a loading & pre-examining module, configured to load a solid substance and pre-examine the solid substance;
a pre-cleaning module, configured to pre-clean the solid substance using a cleaning fluid;
an ultrasonic cleaning module, configured to ultrasonically cleaning the solid substance, wherein the ultrasonic cleaning module includes an ultrasonic resonator;
a drying module, configured to remove moisture of the solid substance;
an unloading & examining module, configured to unload and examine the substance, and
an automatic control module connected to the pre-cleaning module and the ultrasonic cleaning module.

10. The cleaning device according to claim 9, wherein:
the loading & pre-examining module includes a first detection unit for collecting image information of the solid substance, and
the image information collected by the first detection unit is transmitted to the automatic control module to be compared with preset image information, such that a first stain degree of the solid substance is obtained.

11. The cleaning device according to claim 10, wherein:
based on the first stain degree of the solid substance, pressure of the cleaning fluid and cleaning time in the pre-cleaning module are configured.

12. The cleaning device according to claim 11, wherein:
the unloading & examining module includes a second detection unit for collecting image information of the solid substance, and
the image information collected by the second detection unit is transmitted to the automatic control module to be compared with preset image information, such that a second stain degree of the solid substance is obtained.

13. The cleaning device according to claim 12, wherein:
when the second stain degree of the solid substance exceeds a preset value, the solid substance is determined to be ineligible, and
based on a number of ineligible solid substances, frequency of the ultrasonic resonator in the ultrasonic cleaning module is controlled.

14. The cleaning device according to claim 13, wherein:
when the second stain degree of the solid substance exceeds a preset value, a first alarm sound is triggered.

15. The cleaning device according to claim 13, wherein:
when a ratio of ineligible solid substance exceeds a pre-determined value, a second alarm sound is triggered.

16. The cleaning device according to claim 9, further comprising:
a rinsing module disposed between ultrasonic cleaning module and the drying module.

17. The cleaning device according to claim 9, further comprising:
at least one of a recycling module and an air exhausting module.
